(19) United States
(12) Patent Application Publication
(10) Pub. No.: US 2026/0044938 A1
(43) Pub. Date: Feb. 12, 2026

(54) FAST DIFFUSION-BASED IMAGE RESTORATION WORKFLOW VIA SHARING OF INITIAL DIFFUSION STEPS

(71) Applicant: CANON MEDICAL SYSTEMS CORPORATION, Tochigi (JP)

(72) Inventors: Tzu-Cheng LEE, Vernon Hills, IL (US); Xi CHEN, Vernon Hills, IL (US); Liang CAI, Vernon Hills, IL (US)

(73) Assignee: CANON MEDICAL SYSTEMS CORPORATION, Tochigi (JP)

(21) Appl. No.: 18/796,076

(22) Filed: Aug. 6, 2024

(51) Int. Cl. G06T 5/70; G06T 5/50

(52) U.S. Cl. CPC G06T 5/70; G06T 5/50; G06T 2207/20076

(57) ABSTRACT

A method includes obtaining a diffusion-based probabilistic model to perform denoising over T steps; determining a shared phase representative image based on a plurality of phase images; generating a sequence of representative images by performing a first sequence of T1 denoising sampling steps using the obtained model starting with a start image and the shared phase representative image as initial first sequence inputs; determining, from the generated sequence of representative images, an intermediate image; and for each phase image in the plurality of phase images: generating a corresponding sequence of restored images by performing a second sequence of T2 denoising sampling steps using the obtained model with the intermediate image and the input image as initial second sequence inputs; and determining a corresponding final restored image for each phase image based on the corresponding sequence of restored images, wherein T1 and T2 are integers greater than or equal to 1.

### BACKGROUND

### Field

The present disclosure relates to restoration of a series of images.

### Description of the Related Art

Deep learning-based models for image restoration typically use a series of steps to modify an input image to a desired degree. When a sequence of images is acquired, a deep learning model can process the sequence by repeating the series of steps for each image in the series. The number of steps used to process the sequence can affect the processing time and capacity required by the deep learning model.

The foregoing “Background” description is for the purpose of generally presenting the context of the disclosure. Work of the inventors, to the extent it is described in this background section, as well as aspects of the description which may not otherwise qualify as prior art at the time of filing, are neither expressly or impliedly admitted as prior art against the present disclosure.

### SUMMARY

The foregoing paragraphs have been provided by way of general introduction, and are not intended to limit the scope of the following claims. The described embodiments, together with further advantages, will be best understood by reference to the following detailed description taken in conjunction with the accompanying drawings.

In one embodiment, the present disclosure is related to a method of denoising images, including obtaining a diffusion-based probabilistic model that was trained, using at least one target image and at least one conditional image, to perform denoising over T steps, wherein T is an integer greater than or equal to two; obtaining a start image; determining a shared phase representative image based on a plurality of phase images; generating a sequence of representative images by performing a first sequence of T1 denoising sampling steps using the obtained model starting with the start image and the shared phase representative image as initial first sequence inputs; determining, from the generated sequence of representative images, an intermediate image; and for each phase image in the plurality of phase images: generating a corresponding sequence of restored images by performing a second sequence of T2 denoising sampling steps using the obtained model with the intermediate image and the input image as initial second sequence inputs; and determining a corresponding final restored image for each phase image based on the generated corresponding sequence of restored images, wherein T1 and T2 are integers greater than or equal to 1.

In one embodiment, the present disclosure is related to a non-transitory computer-readable storage medium for storing computer readable instructions that, when executed by a computer, cause the computer to perform a method, the method including obtaining a diffusion-based probabilistic model that was trained, using at least one target image and at least one conditional image, to perform denoising over T steps, wherein T is an integer greater than or equal to two; obtaining a start image; determining a shared phase representative image based on a plurality of phase images; generating a sequence of representative images by performing a first sequence of T1 denoising sampling steps using the obtained model starting with the start image and the shared phase representative image as initial first sequence inputs; determining, from the generated sequence of representative images, an intermediate image; and for each phase image in the plurality of phase images: generating a corresponding sequence of restored images by performing a second sequence of T2 denoising sampling steps using the obtained model with the intermediate image and the input image as initial second sequence inputs; and determining a corresponding final restored image for each phase image based on the generated corresponding sequence of restored images, wherein T1 and T2 are integers greater than or equal to 1.

In one embodiment, the present disclosure is related to an apparatus, including processing circuitry configured to obtain a diffusion-based probabilistic model that was trained, using at least one target image and at least one conditional image, to perform denoising over T steps, wherein T is an integer greater than or equal to two; obtain a start image; determine a shared phase representative image based on a plurality of phase images; generate a corresponding sequence of representative images by performing a first sequence of T1 denoising sampling steps using the obtained model starting with the start image and the shared phase representative image as initial first sequence inputs; determine, from the generated sequence of representative images, an intermediate image; and for each phase image in the plurality of phase images: generate a corresponding sequence of restored images by performing a second sequence of T2 denoising sampling steps using the obtained model with the intermediate image and the input image as initial second sequence inputs; and determine a final restored image for each phase image based on the generated corresponding sequence of restored images, wherein T1 and T2 are integers greater than or equal to 1.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is a schematic of a diffusion-based image restoration workflow according to one embodiment of the present disclosure;

FIG. 1B is a schematic of a process for denoising a series of multiphasic images using a trained DDPM according to one embodiment of the present disclosure;

FIG. 2 is a schematic of the multiphasic imaging diffusion-based denoising method according to one embodiment of the present disclosure;

FIG. 3 shows a non-limiting example of a flow chart for a method of joint multiphasic imaging diffusion-based denoising according to one embodiment of the present disclosure;

FIG. 4 is a schematic of automatically determining the shared sampling step number according to one embodiment of the present disclosure;

FIG. 5 illustrates the results of the joint multiphasic imaging diffusion-based denoising according to one embodiment of the present disclosure;

FIG. 6 is a schematic of a hardware system for performing a method according to one embodiment of the present disclosure; and

FIG. 7 is a schematic of an imaging system according to one embodiment of the present disclosure.

### DETAILED DESCRIPTION

Referring now to the drawings, wherein like reference numerals designate identical or corresponding parts throughout the several views.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

In one embodiment, the present disclosure is directed to systems and methods for image restoration using deep learning-based models. Image restoration techniques can include, but are not limited to, denoising, deblurring, resolution enhancement (e.g., super-resolution imaging), and image/signal reconstruction (e.g., compressed sensing). Each of these techniques can be used independently or in combination to improve the visibility of features in an image. Image restoration has important applications for medical imaging modalities such as computed topography (CT) scanning, magnetic resonance imaging (MRI), etc., which are often subject to noise due to physical interactions within the imaging systems. It can be appreciated that the systems and methods described herein are not limited to medical imaging applications and can be used for various imaging types and techniques. In particular, the methods of the present disclosure can be useful for processing any volumes of image data (e.g., a series of images or image slices) that are acquired over a spatial or temporal span.

Generative deep learning-based models can be used to reduce noise and similar artifacts in an acquired image in order to generate a restored image that is of higher quality than the acquired image. In one embodiment, a generative model can be used to denoise an image by converting a first data distribution (noisy image data) to a second data distribution (restored image data). In one embodiment, the generative model can be a denoising diffusion probabilistic model (DDPM). It can be appreciated that DDPMs are described herein as an illustrative example of a class of generative models, and that other types of probabilistic models and especially diffusion-based probabilistic models for image restoration are also compatible with the methods of the present disclosure.

A DDPM can be used to denoise an image in a series of diffusion steps. The DDPM can be trained to denoise an image in an iterative process, wherein the DDPM generates an increasingly denoised image at each diffusion step. The DDPM can be trained to denoise an image by converting a first probability distribution corresponding to an input image (e.g., a noisy image) to a second probability distribution corresponding to an output image (e.g., a denoised image). In one example, the first probability distribution can be a normal distribution corresponding to normal (Gaussian) noise that is present in an acquired image. The DDPM can be trained to remove the noise by converting the normal probability distribution to a predicted distribution corresponding to a denoised, restored image.

In one embodiment, a DDPM can be trained using a set or sequence of training images. The set of training images can include a target image, which is a clean or denoised image, and noisy images that are generated from the target image. In one embodiment, the noisy training images can be generated by applying modeled noise (e.g., Gaussian noise) to the target image in one or more steps. The set of training images can include images with increasing amounts of noise. The set of training images can further include a pure noise image generated from the target image. In one embodiment, the modeled noise can be similar to or based on an expected type of noise in an acquired image that the DDPM will be used to restore. In one embodiment, the target image can be similar to or based on a type of image that the DDPM will be used to recover. The training images can each be input to the DDPM. The DDPM can be trained to denoise an input training image to output a restored image at each step in a series of diffusion steps. The series of diffusion steps can correspond to the one or more steps used to apply noise to the target image. In this manner, the DDPM can be trained to “reverse” a stepwise process for applying noise to an image in order to remove said noise from the image.

At each diffusion step, the DDPM can be trained to minimize a loss function, the loss function corresponding to a difference in noise between a predicted output image and a training image for the given diffusion step. The DDPM can therefore be trained to accurately predict and model a difference in noise between each input image and an output image at each diffusion step. In one embodiment, the training of the DDPM can include setting one or more weights of the model. The one or more weights of the model can vary for each diffusion step within the series of diffusion steps or for at least one of the diffusion steps within the series. In one embodiment, a conditional image can be input to the DDPM during the training process to guide the generation of output images. In one embodiment, the conditional image can be the target image. The target image used for training the DDPM can be at least one target image and can include more than one target image. For example, the at least one target image can include a low-resolution medical image (e.g., CT image) and an edge-detected medical image (e.g., CT image) or otherwise processed medical image. Similarly, the conditional image used for training the DDPM can be at least one conditional image and can include more than one conditional image. In one example, the at least one conditional image can include a low-resolution medical image (e.g., CT image) and an edge-detected medical image (e.g., CT image), or otherwise processed medical image. In one example, the at least one conditional image or the at least one target image can include three consecutive conditional images for a multi-dimensional (e.g., 2.5 dimensional) process.

In one embodiment, the input to a trained DDPM can be a noisy image, a conditional image, and a diffusion step (also referred to as a time step or sampling step). The DDPM can predict the second probability distribution corresponding to a restored image given the conditional image as a known condition. In one embodiment, the DDPM can denoise a pure noise image in a series of diffusion steps in order to generate a final restored image. The pure noise image can be the first image input to the DDPM. The DDPM can output a denoised image (also referred to herein as a restored image) for each diffusion step. The denoised image output from each diffusion step in the series can be input into a following diffusion step in order to iteratively denoise the pure noise image. The DDPM can include one or more learned weights used to output the restored image, wherein the value of the one or more learned weights can be dependent on the diffusion step. Additional details regarding the training and use of a DDPM for can be found in Ho, J. et. al, (2020). “Denoising diffusion probabilistic models.” Advances in neural information processing systems, 33, 6840-6851 and in Xia, W. et. al, (2022). “Low-Dose CT Using Denoising Diffusion Probabilistic Model for 20× times Speedup.” arXiv preprint arXiv:2209.15136, each of which is incorporated herein by reference in its entirety for all purposes.

In one embodiment, the DDPM can be used to denoise a series of images. The series of images can be acquired in sequence over time or over a spatial dimension. For example, a series of images can be acquired over time via a renal scan in order to evaluate kidney function. In the denoising process (also referred to as an inference process or sampling process), the DDPM can denoise and identify larger or more generalized features in initial denoising (diffusion) steps. These larger features are typically consistent throughout a series of images. For example, the general shape and location of the kidney and structures therein can first be identified in a scan image and are not likely to change within a single renal scan. The DDPM can then denoise and identify smaller features or details in later diffusion steps. In the example of a renal scan, the DDPM can identify finer details of the shape and size of renal structures, as well as the location of any contrast dye within the kidney. These details can change throughout the series of images as the renal system processes fluid in the body. Changes throughout the series of images are likely to be gradual and continuous over time. Therefore, adjacent images in a series of images can be similar to each other.

In another example, a series of images can be acquired through a scan of one or more sections of the body along one or more directions. In a similar manner, the DDPM can first denoise and identify larger features such as the general shape of the section of the body and organs therein. The DDPM can then denoise and identify smaller features and/or finer details of the organs. Adjacent images within the series depict portions of the body that are also in close proximity with each other. Therefore, the adjacent images in the series are also likely to be similar to each other and share large features as the scan progresses along the body.

In another example, a series of images can be acquired in sequence over time and while a contrast agent is processed by the patient's body. Multiphasic imaging, which can be used in CT and MRI, is a technique that includes acquiring scans at different time points after an injection of the intravenous contrast. Multiphasic imaging can be performed to optimize the visualization of different structures or pathologies that have different contrast enhancement patterns. Multiphasic imaging can help detect and characterize vascular lesions, tumors, ischemia, inflammation, or trauma in various organs. By comparing the images obtained at different phases, such as a non-contrast phase, an arterial phase, a (portal) venous phase, and/or a delayed phase, a radiologist or similar operator can assess a blood flow, perfusion, and excretion of contrast in tissues of interest. Notably, for a multiphasic imaging dataset, which usually includes 3 to 4 times the total volume of images compared to single phase imaging, the total processing time for diffusion-based restoration will be incredibly lengthy. Thus, a cross-acquisition acceleration mechanism is desired.

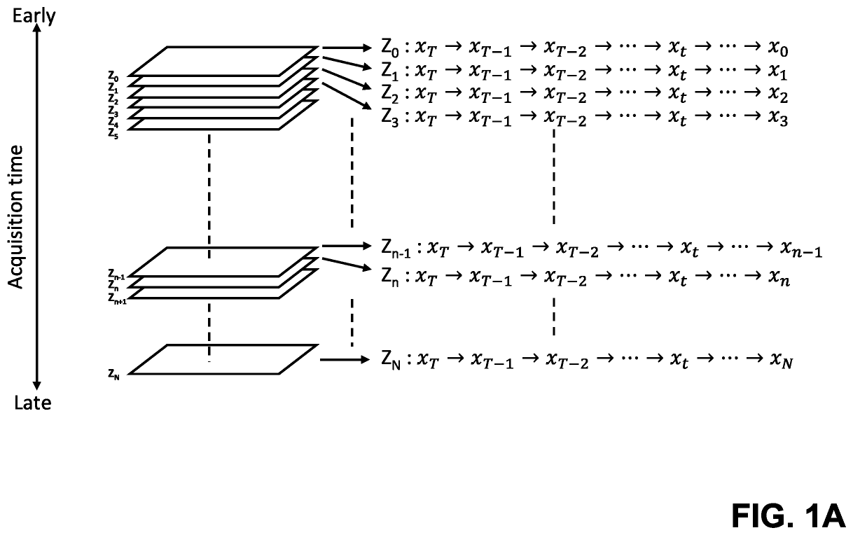

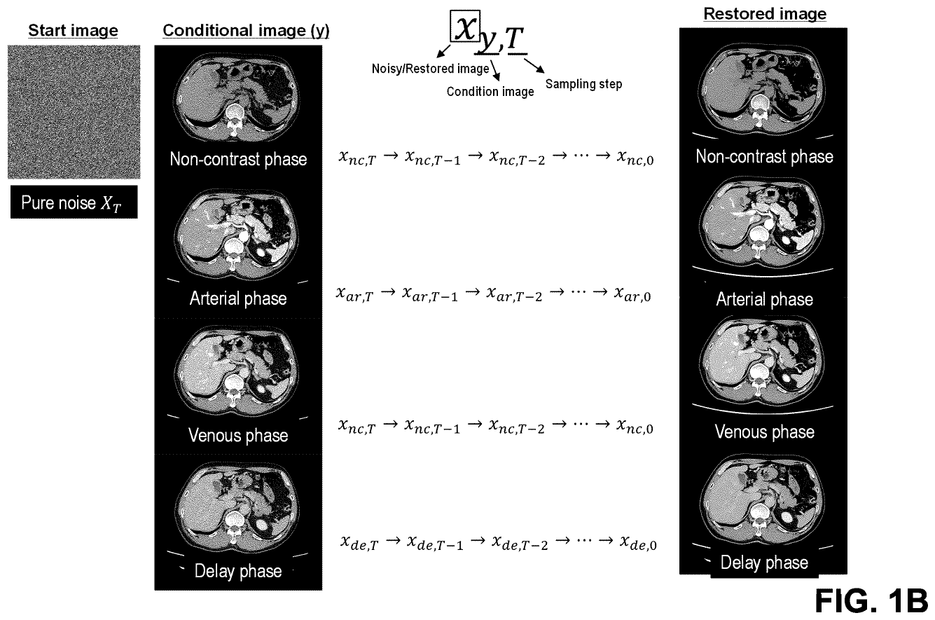

FIG. 1A is a schematic of a process for denoising a series of N images (Z₀, Z₁, Z₂, Z₃, Z₄, Z₅, . . . . Z_{N}) using a trained DDPM. The series of N images can be collected over a period of time or along a spatial direction. For each image in the series of images, a pure noise image x_{T} can be input to the DDPM. The pure noise image x_{T} can be generated using a probability distribution model, such as a Gaussian distribution. A conditional image can also be input to the DDPM for the denoising process. In one embodiment, the conditional image can be the image (one of the series Z₀, Z₁, Z₂, Z₃, Z₄, Z₅, . . . Z_{N}) that is being denoised. The conditional image can include more than one conditional images, such as an edge-detected image or otherwise processed image.

The DDPM can be used to denoise each image (Z₀, Z₁, Z₂, Z₃, Z₄, Z₅, . . . Z_{N}) in a series of T diffusion steps. The DDPM can denoise the pure noise image x_{T} in a series of T diffusion steps to generate a corresponding sequence of restored images x_{T-1}, x_{T-2}, etc. for each image in the series. At each diffusion step, the restored image from the previous diffusion step can be input to the DDPM along with the conditional image and the timestep (T−1,T−2, etc.). For example, the DDPM can denoise the pure noise image x_{T} based on the conditional image Z₀ to generate the restored image x_{T-1} at time step T−1. The DDPM can then denoise the image x_{T-1} based on the conditional image Z₀ to generate a further restored image x_{T-2} at time step T−2. At time step T, the DDPM can output an image x₀ that is a denoised version of the conditional image Z₀. After T time steps for each image (Z₀, Z₁, Z₂, Z₃, Z₄,Z₅, . . . Z_{N}), the DDPM can output a corresponding denoised image (x₀, x₁, x₂, x₃, x₄, x₅, . . . x_{N}). In this manner, the DDPM performs N*T diffusion steps to denoise every image in the series of images.

FIG. 1B is a schematic of a process for denoising a series of multiphasic images using a trained DDPM. The series of multiphasic images can be collected over a period of time, such as before, during, and after injection of a contrast agent. For each image in the series of multiphasic images, a pure noise image x_{T} can be input to the DDPM. The pure noise image x_{T} can be generated using a probability distribution model, such as a Gaussian distribution. A conditional image (y) can also be input to the DDPM for the denoising process. In one embodiment, the conditional image can be the image that is being denoised. The conditional image can include more than one conditional images, such as an edge-detected image or otherwise processed image. The series of multiphasic images can be divided into one or more sets of phase images. As shown, the series of multiphasic images can be divided into four sets of phase images, wherein a first set of phase images corresponds to a non-contrast phase of the imaging, a second set of phase images corresponds to an arterial phase of the imaging, a third set of phase images corresponds to a venous phase of the imaging, and a fourth set of phase images corresponds to a delay phase of the imaging.

In one embodiment, the present disclosure is directed towards bulk diffusion methods of image denoising that take advantage of similarities between adjacent images in a series of images to achieve faster denoising of the series of multiphasic images using a diffusion-based probability model. The methods described herein can reduce the number of diffusion steps needed to denoise a series of multiphasic images while retaining inference accuracy. Reducing the number of diffusion steps can result in faster denoising as well as reduced computational power usage.

In one embodiment, the method can include dividing the images in a series of multiphasic images and performing initial batch denoising on the sets of images using a trained DDPM. A set of the multiphasic images can be a subset of adjacent images within the series of multiphasic images that are collected over a period of time. The series of multiphasic images can be divided into one or more sets, wherein each set can include one or more images. Each of the one or more sets of multiphasic images can have the same or a different number of images. For example, a first set of images can include the first n images in a series, a second set of images can include the subsequent n+1 to n+m images in a series, etc. For example, the number of images in a group can be set such that one or more features or a type of feature (e.g., features of a certain size, features of a certain pixel brightness based on contrast agent level, etc.) are constant in each image of the group.

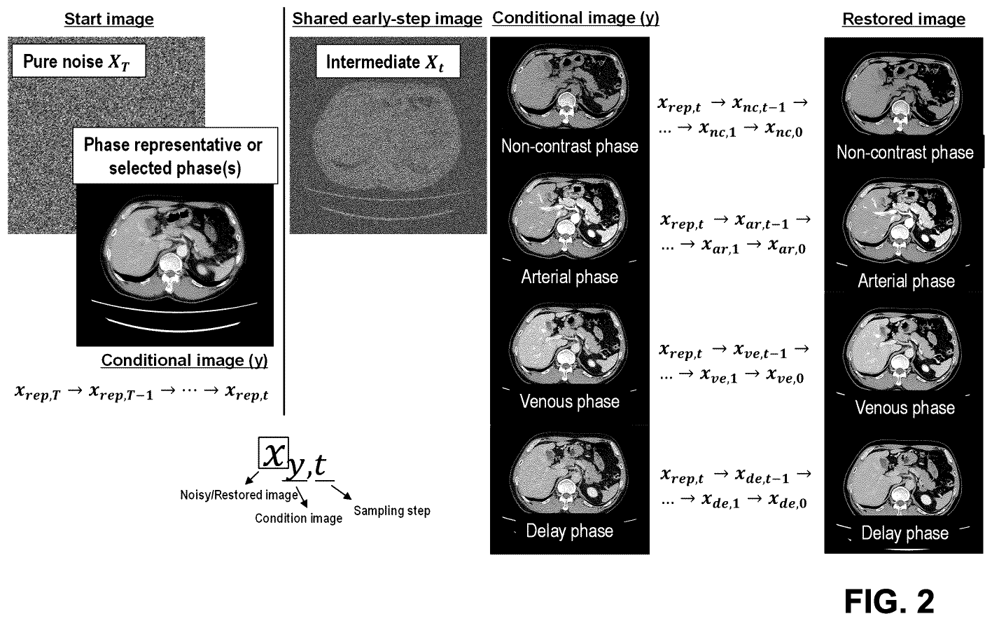

FIG. 2 is a schematic of the multiphasic imaging diffusion-based denoising method, according to one embodiment of the present disclosure. In one embodiment, a shared phase representative image can be determined for the conditional image. The shared phase representative image can be determined from the series of multiphasic images. In one example, the shared phase representative image can be generated by computing an average value for each pixel across all of the images in each set of the one or more sets of phase images. In one embodiment, the shared phase representative image can be an image of a set of the one or more sets of phase images (e.g., a first image, an nth image, an

$$\frac{n}{2} th$$

image). In one embodiment, the shared phase representative image can be a preprocessed image, such as an image that has been processed in the frequency domain and weighted. The shared phase representative image can be generated via any combination of image computation and processing and is not limited to the examples provided herein. The shared phase representative image can be input as a conditional image to the DDPM at each diffusion step in a series of initial diffusion steps. The number of initial diffusion steps can be represented by the quantity T1. The DDPM can denoise a pure noise image over T1 initial diffusion steps using the shared phase representative image as the conditional image. As will be described below, the DDPM can be trained to denoise an image in a series of T total diffusion steps, where T=T1+T2.

The features identified by the DDPM in the initial T1 diffusion steps are likely to be consistent throughout each image in the series of multiphasic images. Therefore, denoising that is conditioned on the shared phase representative image rather than on each image in the series of multiphasic images is sufficient for the initial diffusion steps for any of the images in the series of multiphasic images. The number of initial diffusion steps for which the shared phase representative image is used as a conditional image can be modulated based on the total number of diffusion steps (T), the type of scan, expected features in the series of images, etc. For example, the number of initial diffusion steps can be set such that the DDPM can identify features that are present in each image in the series of multiphasic images within the initial diffusion steps.

In one embodiment, the DDPM can output an intermediate restored image (Xₜ) after the final (T1) step of the series of initial diffusion steps. The intermediate restored image can be generated by the DDPM from a pure noise image using the shared phase representative image as a conditional image. In one embodiment, the intermediate restored image can include one or more features that are shared across each multiphasic image in the series of multiphasic images. After the T1 initial diffusion steps, the appearance of each image in the series of multiphasic images may diverge. For example, the appearance of contrast agent at various intensities or locations, finer details, or smaller features can differ for each image in the series of multiphasic images. These features may not be distinguishable by the DDPM until the completion of the T1 initial diffusion steps. The T1 initial diffusion steps can result in the intermediate restored image wherein the larger and less-detailed features that the images in the series of multiphasic images have in common are denoised and visible.

Therefore, the T1 initial diffusion steps can be shared among each image in the series of multiphasic images and does not need to be repeated by the DDPM for each image.

In one embodiment, the intermediate restored image generated from the T1 initial diffusion steps can be used as an input image for further diffusion steps conditioned on each image in the series of multiphasic images. The DDPM can denoise the intermediate restored image using the images in each set of the one or more sets of phase images as a conditional image to generate a restored image for each image in each set of the one or more sets of phase images. The denoising of the intermediate restored image conditioned on each image can be performed over T2 diffusion steps. The DDPM can then output final restored images corresponding to the images in each set of the one more sets of phase images. In this manner, the DDPM can reduce the number of diffusion steps needed to denoise each image in each set of the one more sets of phase images by performing a single series of T1 initial diffusion steps using the shared phase representative image as a conditional image to generate the intermediate restored image. The DDPM can then denoise the intermediate restored image in T2 diffusion steps for each image of the one or more sets of phase images to generate the output images. This method eliminates the need to repeat the T1 initial diffusion steps for each of the images in the one or more sets of phase images. The remaining T2 diffusion steps can be used to identify and denoise features that are unique to each image in the one or more sets of phase images or that are distinct in an image.

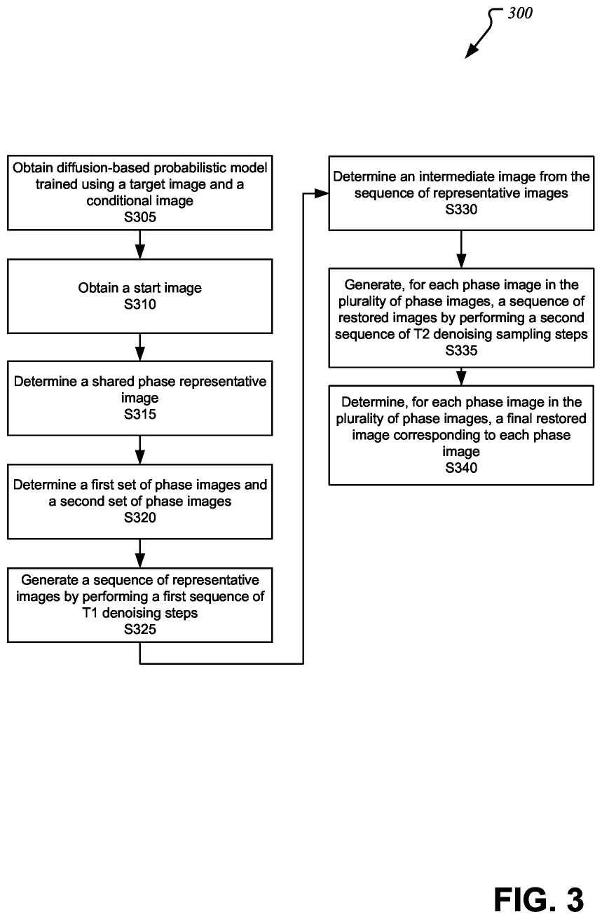

FIG. 3 shows a non-limiting example of a flow chart for a method 300 of joint multiphasic imaging diffusion-based denoising, according to one embodiment of the present disclosure. In one embodiment, a trained DDPM can be used to denoise a series of multiphasic images. The series of multiphasic images can be collected over a period of time, such as before, during, and after injection of a contrast agent in a patient.

In one embodiment, step S305 is obtaining a diffusion-based probabilistic model that was trained, using at least one target image and at least one conditional image, to perform denoising over T steps, wherein T is an integer greater than or equal to two.

In one embodiment, step S310 is obtaining a start image, which can be a pure noise image. The pure noise image x̅_{T} can be input to the DDPM.

In one embodiment, step S315 is determining a shared phase representative image based on a plurality of images. The plurality of images can be, for example, the series of multiphasic images.

In one embodiment, step S320 is determining a first set of phase images and a second set of phase images from the plurality of images. Additional sets of phase images can also be determined from the plurality of images. In one embodiment, determining the first set of phase images and the second set of phase images from the plurality of images further comprises determining a first set of the plurality of images within a first time frame includes a first level of contrast agent below a first threshold value and determining a second set of the plurality of images within a second time frame includes a second level of contrast agent at or above the first threshold value.

In one embodiment, step S325 is generating a sequence of representative images by performing a first sequence of T1 denoising sampling steps using the obtained model starting with the start image and the shared phase representative image as initial first sequence inputs. A representative image, such as the shared phase representative image, can be input as a conditional image (y) to the DDPM. The shared phase representative image can be, for example, an average of the plurality of images. The DDPM can denoise the pure noise (starting) image x-based on the conditional (shared phase representative) image in a series of T1 initial diffusion steps to generate a sequence of (restored) representative images, wherein T1<T. At each diffusion step, the restored shared phase representative image from the previous diffusion step can be input to the DDPM along with the conditional image and the timestep (T−1, T−2, etc.). For example, the DDPM can denoise the pure noise image x̅_{T} based on the conditional image to generate the restored representative image x̅_{T-1} at time step T−1. The DDPM can then denoise the image x̅_{T-1} based on the conditional image to generate a further restored (denoised) representative image x̅_{T-2} at time step T−2.

In one embodiment, step S330 is determining, from the sequence of representative images, an intermediate image. After T1 diffusion steps, the DDPM can output a (restored) intermediate image x̅ₜ that has been generated using the shared phase representative image as the conditional image. The intermediate image x̅ₜ can be a last image of the sequence of representative images generated by the DDPM in the T1 diffusion steps.

In one embodiment, step S335 is for each phase image in each set of phase images, generating a corresponding sequence of restored images by performing a second sequence of T2 denoising sampling steps using the obtained model with the intermediate image and the input image as initial second sequence inputs. The DDPM can then be used to denoise the intermediate image x̅ₜ using each of the images in each set of the one or more sets of phase images. For example, the DDPM can denoise the intermediate image x̅ₜ using the images from the set of non-contrast phase images as the conditional images in a series of subsequent diffusion steps to output a final restored image x₀ corresponding to the original image.

In one embodiment, step S340 is for each phase image in each set of phase images, determining a corresponding final restored image for each phase image based on the generated corresponding sequence of restored images. The DDPM can denoise the intermediate image x̅ₜ using a first non-contrast phase image in the first set of phase images as the conditional image in a series of subsequent diffusion steps to output a first final restored image corresponding to the original first non-contrast phase image in the first set of phase images. The DDPM can denoise the intermediate image x̅ₜ using a second non-contrast phase image as the conditional image in a series of subsequent diffusion steps to output a second final restored image corresponding to the original second non-contrast phase image in the first set of phase images, etc. In one embodiment, the DDPM can denoise the intermediate image x̅ₜ in t subsequent diffusion steps, wherein t+T1=T total diffusion steps. The t subsequent diffusion steps can be referred to herein with the quantity T2. In this manner, the DDPM can denoise each image in a series N of multiphasic images using T1+ (T2*N) diffusion steps, wherein T1+T2=T. This method reduces the number of diffusion steps needed in comparison with the method illustrated in FIG. 1A, which uses N*T steps to diffuse a series of N images.

The process of generating the intermediate image for a series of multiphasic images and denoising the intermediate image conditioned on each image in the set of phase images can be repeated for each set of the one or more sets of phase images. Each set of the one or more sets of phase images can include the same or a different number of images. The number of initial diffusion steps T1 and the number of subsequent diffusion steps T2 can vary for each set of the one or more sets of phase images or can be the same for each set of the one or more sets of phase images. In one embodiment, the number of initial diffusion steps T1 can be referred to as a length of the initial diffusion process using the shared phase representative images. The length of the initial diffusion process can be modulated based on the expected content of the images in the set of phase images. For example, the length of the initial diffusion process can be modulated based on an expected size of one or more features. In one embodiment, the length of the initial diffusion process and/or the number of total diffusion steps (T) can be dependent on the training of the DDPM.

In one embodiment, an image can be downsampled prior to a diffusion step. For example, the shared phase representative image of a set of phase images can be downsampled prior to initial diffusion steps so that the downsampled shared phase representative image is smaller in size than the original images of the set of phase images. Downsampling the shared phase representative image can reduce the processing time or capacity needed to denoise the shared phase representative image in the initial diffusion steps. The shared phase representative image can be downsampled without affecting the appearance of features that are identified (denoised) in the initial diffusion steps.

In one embodiment, the final intermediate image x̅ₜ that is generated after T1 initial diffusion steps can be upsampled prior to the remaining T2 diffusion steps that are conditioned on the individual images in the set of phase images. The upsampling can resize the intermediate image x̅ₜ so that the image x̅ₜ is the same size as any of the original images of the set of phase images. The upsampling can restore image data that is needed for denoising of smaller details in the images.

In one embodiment, various parameters can be modulated for the method 300. The parameters can be shared between the sets of phase images or can be different for one or more sets of phase images. In one embodiment, the shared phase representative image (conditional image (y)) can vary and impact an image quality of the final restored image(s). In one embodiment, the initial shared sampling step (T−t) can determine how many sampling steps are recovered with the shared conditional image. The more numerous the shared sampling steps, the faster the method 300 will process or complete. In one embodiment, the shared sampling step for each set of phase images (T−tₐ, T−t_{b}, etc. where a and b denote a determined, separate phase) can be different for different following restoration phases depending on a level of anatomical differences between the conditional image and the intermediate image. In one embodiment, a look-up-table (LUT) can be used to determine how many sampling steps can be recovered by providing recommended or predicted optimal shared conditional images based on any one of historical scan and image reconstruction data, scan parameters, patient data, contrast agent parameters, etc. In one embodiment, the shared conditional image can be selected by an operator. In one embodiment, a combination of the LUT and the manual operator selection can be used to determine the shared conditional image. In one embodiment, the shared conditional image can automatically be determined by processing circuitry. The processing circuitry can determine an image difference for a last image in the sequence of representative images compared to a first image in the first set of phase images and a first image in the second set of phase images is greater than a predetermined threshold and select a preceding image preceding the last image in the sequence of representative images.

By taking advantage of similar anatomical structure between phases, and assuming the noisy (early sampling step), low-detail intermediate image of multiphasic images would be very similar, significant processing time can be saved without much cost in image quality when using an appropriate conditional image and shared sampling step.

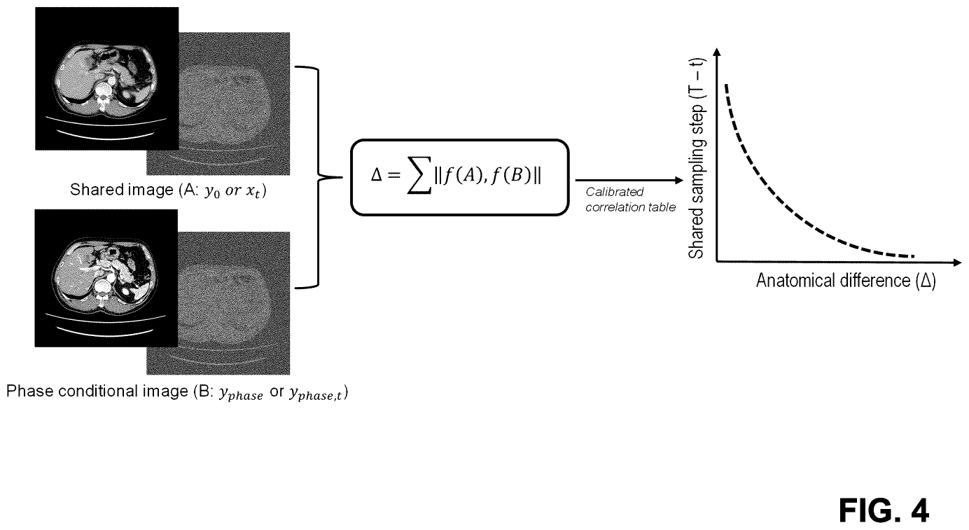

FIG. 4 is a schematic of automatically determining the shared sampling step number, according to one embodiment of the present disclosure. In one embodiment, the shared sampling step (T−t) and its variational form (tₐ, t_{b}, . . . ) for each phasic image is essential for balancing output image quality and processing time. Therefore, a new method for automatically selecting the shared sampling step number in the processing workflow can be very helpful since the early sampling step in the diffusion inference process is more related to low-frequency features (e.g., shape & different anatomical segment). A feature difference measurement between the shared conditional image (y) or intermediate image (xₜ) to the following phase condition image (yₚₕₐₛₑ, or simulated conditional image in intermediate noise state y_{phase,t}) can be used to determine the length of t. The difference function (f) can be, for example, a low pass filter.

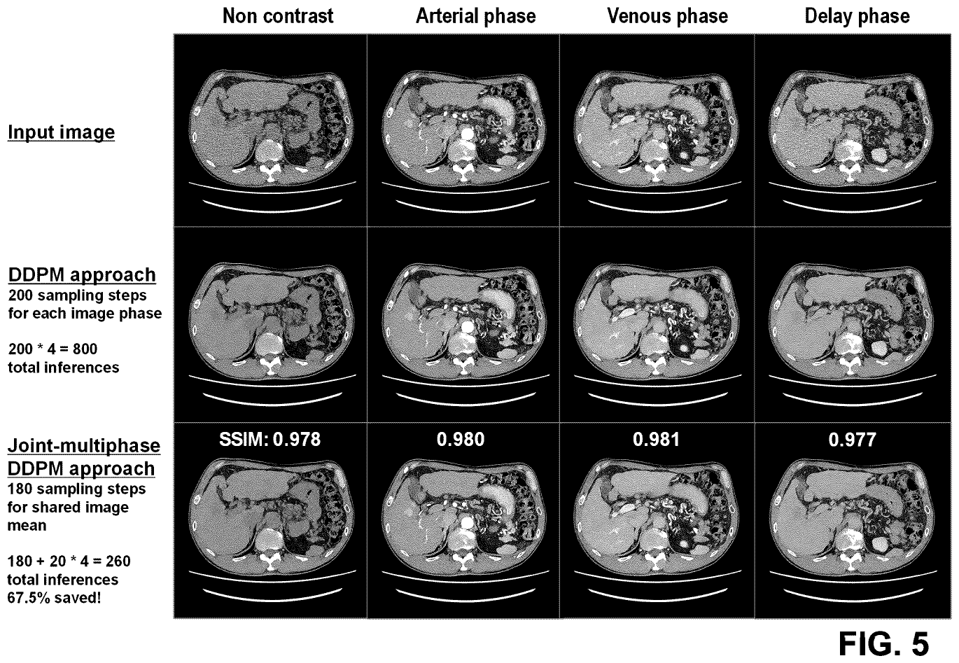

FIG. 5 illustrates the results of the joint multiphasic imaging diffusion-based denoising, according to one embodiment of the present disclosure. In one embodiment, FIG. 5 is an illustration of various input images during imaging of an injected contrast agent that are divided into four sets of phase images (top row). The DDPM can denoise each set of phase images. The series of images can be denoised by the DDPM using 200 diffusion or samplings steps for each image, resulting in 800 total diffusion steps or inferences (middle row). The series of images can be denoised by the DDPM using the joint multiphasic imaging diffusion-based denoising, wherein T1=180 and T2=20. Therefore, the series of multiphasic images can be denoised using 190+ (20*4)=260 diffusion steps, resulting in a 67.5% reduction in processing. The denoised images of the middle row of FIG. 5 using the DDPM approach and the top row of FIG. 5 using the joint multiphasic imaging diffusion-based denoising have the same quality and level of recovery as indicated by the structural similarity index measure (SSIM) values listed that are greater than 0.95. Of course, the values for T1 and T2 can be adjusted to increase or decrease the processing used based on the output image quality.

The systems and methods described herein are compatible with other methods for reducing the processing time of a diffusion-based image denoising model. Such methods can include, but are not limited to, using a denoising diffusion implicit model; reducing the number of diffusion steps T; implementing an early stop to the diffusion process; using a fast ordinary differential equation solver; pre-segmentation diffusion sampling; and using a high-frequency space diffusion model.

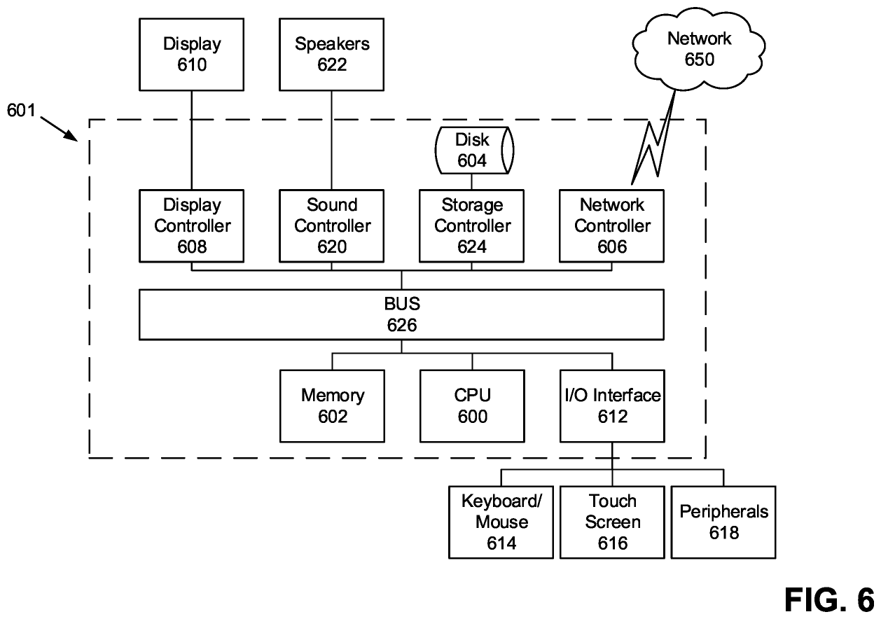

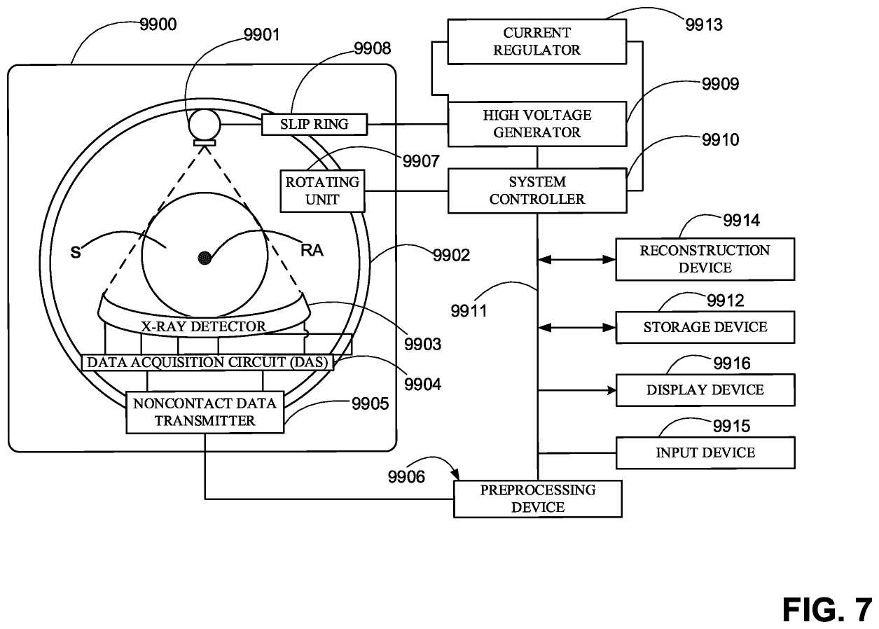

Next, a hardware description of a device 601 according to exemplary embodiments is described with reference to FIG. 6. In FIG. 6 the device 601 includes processing circuitry. The device 601 can be used to execute any of the methods described herein related to obtaining the DDPM, training the DDPM, receiving acquired images, and/or denoising an image using the DDPM. In one embodiment, the device 601 can be a server, a computer, etc. In one embodiment, the device 601 can be in communication with or embedded in an image acquisition device, such as the CT device illustrated in FIG. 7. In one embodiment, the methods described herein can be distributed across one or more devices, the one or more devices including at least some of the elements of device 601. The processing circuitry includes one or more of the elements discussed next with reference to FIG. 6. The process data and instructions may be stored in memory 602. These processes and instructions may also be stored on a storage medium disk 604 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device 601 communicates, such as a server or computer.

Further, the claimed advancements may be provided as a utility application, background daemon, or component of an operating system, or combination thereof, executing in conjunction with CPU 600 and an operating system such as Microsoft Windows, UNIX, Solaris, LINUX, Apple MAC-OS and other systems known to those skilled in the art.

The hardware elements in order to achieve the device 601 may be realized by various circuitry elements, known to those skilled in the art. For example, CPU 600 may be a Xenon or Core processor from Intel of America or an Opteron processor from AMD of America, or may be other processor types that would be recognized by one of ordinary skill in the art. Alternatively, the CPU 600 may be implemented on an FPGA, ASIC, PLD or using discrete logic circuits, as one of ordinary skill in the art would recognize. Further, CPU 600 may be implemented as multiple processors cooperatively working in parallel to perform the instructions of the processes described above.

The device 601 in FIG. 6 also includes a network controller 606, such as an Intel Ethernet PRO network interface card from Intel Corporation of America, for interfacing with network 650. and to communicate with the other devices. As can be appreciated, the network 650 can be a public network, such as the Internet, or a private network such as an LAN or WAN network, or any combination thereof and can also include PSTN or ISDN sub-networks. The network 650 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The device 601 further includes a display controller 608, such as a NVIDIA GeForce GTX or Quadro graphics adaptor from NVIDIA Corporation of America for interfacing with display 610, such as an LCD monitor. A general purpose I/O interface 612 interfaces with a keyboard and/or mouse 614 as well as a touch screen panel 616 on or separate from display 610. General purpose I/O interface also connects to a variety of peripherals 618 including printers and scanners.

A sound controller 620 is also provided in the device 601 to interface with speakers/microphone 622 thereby providing sounds and/or music.

The general purpose storage controller 624 connects the storage medium disk 604 with communication bus 626, which may be an ISA, EISA, VESA, PCI, or similar, for interconnecting all of the components of the device 601. A description of the general features and functionality of the display 610, keyboard and/or mouse 614, as well as the display controller 608, storage controller 624, network controller 606, sound controller 620, and general purpose I/O interface 612 is omitted herein for brevity as these features are known.

In one embodiment, the images processed using the bulk diffusion methods described herein can be CT images acquired by a CT apparatus or scanner. FIG. 7 illustrates an implementation of a radiography gantry included in a CT apparatus or scanner. As shown in FIG. 7, a radiography gantry 9900 is illustrated from a side view and further includes an X-ray tube 9901, an annular frame 9902, and a multi-row or two-dimensional-array-type X-ray detector 9903. The X-ray tube 9901 and X-ray detector 9903 are diametrically mounted across an object, such as, for example, a patient, on the annular frame 9902, which is rotatably supported around a rotation axis RA. A rotating unit 9907 rotates the annular frame 9902 at a high speed, such as, for example, 0.4 sec/rotation, while the object is being moved along the axis RA into or out of the illustrated page.

An embodiment of an X-ray computed tomography (CT) apparatus according to the present disclosure will be described below with reference to the views of the accompanying drawing. Note that X-ray CT apparatuses include various types of apparatuses, e.g., a rotate/rotate-type apparatus in which an X-ray tube and X-ray detector rotate together around an object to be examined, and a stationary/rotate-type apparatus in which many detection elements are arrayed in the form of a ring or plane, and only an X-ray tube rotates around an object to be examined. The present disclosure can be applied to either type. In this case, the rotate/rotate type, which is currently the mainstream, will be exemplified.

The multi-slice X-ray CT apparatus further includes a high voltage generator 9909 that generates a tube voltage applied to the X-ray tube 9901 through a slip ring 9908 such that the X-ray tube 9901 generates X-rays. An X-ray detector 9903 is located at an opposite side from the X-ray tube 9901 across the object for detecting the emitted X-rays that have transmitted through the object. The X-ray detector 9903 is for example a photon-counting detector. The X-ray detector, or the photon-counting detector 9903 further includes individual detector elements or units, such as, for example, processing circuitry.

The CT apparatus further includes other devices for processing the detected signals from X-ray detector 9903. A data acquisition circuit or a Data Acquisition System (DAS) 9904 converts a signal output from the X-ray detector 9903 for each channel into a voltage signal, amplifies the signal, and further converts the signal into a digital signal. The X-ray detector 9903 and the DAS 9904 are configured to manage a predetermined total number of projections per rotation (TPPR).

The above-described data is sent to a preprocessing device 9906, which is housed in a console outside the radiography gantry 9900 through a non-contact data transmitter 9905. The preprocessing device 9906 performs certain corrections. A memory 9912 stores the resultant data, which is also called projection data at a stage immediately before reconstruction processing. The memory 9912 is connected to a system controller 9910 through a data/control bus 9911, together with a reconstruction device 9914, input device 9915, and display 9916. The system controller 9910 controls a current regulator 9913 that limits the current to a level sufficient for driving the CT system.

The detectors are rotated and/or fixed with respect to the object being scanned, such as the patient, among various generations of the CT scanner systems. In one implementation, the above-described CT system can be an example of a combined third-generation geometry and fourth-generation geometry system. In the third-generation system, the X-ray tube 9901 and the X-ray detector 9903 are diametrically mounted on the annular frame 9902 and are rotated around the object as the annular frame 9902 is rotated about the rotation axis RA. In the fourth-generation geometry system, the detectors are fixedly placed around the patient and an X-ray tube 9901 rotates around the patient. In an alternative embodiment, the radiography gantry 9900 has multiple detectors arranged on the annular frame 9902, which is supported by a C-arm and a stand.

Post-reconstruction processing performed by the reconstruction device 9914 can include filtering and smoothing the image, volume rendering processing, and image difference processing as needed. The image reconstruction process can implement various CT image reconstruction methods. The reconstruction device 9914 can use the memory to store, e.g., projection data, reconstructed images, calibration data and parameters, and computer programs.

While this specification contains many specific implementation details, these should not be construed as limitations on the scope of what may be claimed, but rather as descriptions of features that may be specific to particular embodiments.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Embodiments of the present disclosure may also be as set forth in the following parentheticals.

(1) A method of denoising images, including obtaining a diffusion-based probabilistic model that was trained, using at least one target image and at least one conditional image, to perform denoising over T steps, wherein T is an integer greater than or equal to two; obtaining a start image; determining a shared phase representative image based on a plurality of phase images; generating a sequence of representative images by performing a first sequence of T1 denoising sampling steps using the obtained model starting with the start image and the shared phase representative image as initial first sequence inputs; determining, from the generated sequence of representative images, an intermediate image; and for each phase image in the plurality of phase images: generating a corresponding sequence of restored images by performing a second sequence of T2 denoising sampling steps using the obtained model with the intermediate image and the input image as initial second sequence inputs; and determining a corresponding final restored image for each phase image based on the generated corresponding sequence of restored images, wherein T1 and T2 are integers greater than or equal to 1.

(2) The method of (1), wherein T1 is greater than T2.

(3) The method of (1), wherein T1 is less than T2.

(4) The method of any one of (1) to (3), wherein the step of generating the corresponding sequence of restored images comprises, for each sampling step in the sequence, supplying, as input to the obtained model, a preceding one of the sequence of restored images for phase image, and a value indicating the sampling step.

(5) The method of any one of (1) to (4), wherein the determining the intermediate image further comprises: determining an image difference for a last image in the sequence of representative images compared to a first image in a first set of phase images and a first image in a second set of phase images is greater than a predetermined threshold; and selecting a preceding image preceding the last image in the sequence of representative images.

(6) The method of any one of (1) to (5), further comprising determining the first set of phase images and the second set of phase images from the plurality of phase images by: determining a first set of the plurality of phase images within a first time frame includes a first level of contrast agent below a first threshold value; and determining a second set of the plurality of phase images within a second time frame includes a second level of contrast agent at or above the first threshold value.

(7) The method of any one of (1) to (6), wherein the step of determining the shared phase representative image comprises determining an average of each image of the plurality of phase images.

(8) The method of any one of (1) to (7), further comprising obtaining the plurality of phase images as a time sequence of reconstructed medical images.

(9) The method of any one of (1) to (8), further comprising determining the number T1 of denoising sampling steps for the generating of the sequence of representative images via a look-up table.

(10) The method of any one of (1) to (9), further comprising determining the number T1 of denoising sampling steps for the generating of the sequence of representative images via a manual input from an operator.

(11) a non-transitory computer-readable storage medium for storing computer readable instructions that, when executed by a computer, cause the computer to perform a method, the method including obtaining a diffusion-based probabilistic model that was trained, using at least one target image and at least one conditional image, to perform denoising over T steps, wherein T is an integer greater than or equal to two; obtaining a start image; determining a shared phase representative image based on a plurality of phase images; generating a sequence of representative images by performing a first sequence of T1 denoising sampling steps using the obtained model starting with the start image and the shared phase representative image as initial first sequence inputs; determining, from the generated sequence of representative images, an intermediate image; and for each phase image in the plurality of phase images: generating a corresponding sequence of restored images by performing a second sequence of T2 denoising sampling steps using the obtained model with the intermediate image and the input image as initial second sequence inputs; and determining a corresponding final restored image for each phase image based on the generated corresponding sequence of restored images, wherein T1 and T2 are integers greater than or equal to 1.

(12) The apparatus of (11), wherein T1 is greater than T2.

(13) The apparatus of (11), wherein T1 is less than T2.

(14) The apparatus of any one of (11) to (13), wherein the processing circuitry is further configured to generate the corresponding sequence of restored images by for each sampling step in the sequence, supplying, as input to the obtained model, a preceding one of the sequence of restored images for the phase image, and a value indicating the sampling step.

(15) The apparatus of any one of (11) to (14), wherein the processing circuitry is further configured to determine the intermediate image by determining an image difference for a last image in the sequence of representative images compared to a first image in a first set of phase images and a first image in a second set of phase images is greater than a predetermined threshold, and selecting a preceding image preceding the last image in the sequence of representative images.

(16) The apparatus of any one of (11) to (15), wherein the processing circuitry is further configured to determine the first set of phase images and the second set of phase images from the plurality of phase images by: determining a first set of the plurality of phase images within a first time frame includes a first level of contrast agent below a first threshold value; and determining a second set of the plurality of phase images within a second time frame includes a second level of contrast agent at or above the first threshold value.

(17) The apparatus of any one of (11) to (16), wherein the processing circuitry is further configured to determine the shared phase representative image by calculating an average of the plurality of phase images.

(18) The apparatus of any one of (11) to (17), wherein the processing circuitry is further configured to obtain the plurality of phase images as a time sequence of reconstructed medical images.

(19) The apparatus of any one of (11) to (18), wherein the processing circuitry is further configured to determine the number T1 of denoising sampling steps for the generating of the sequence of representative images via a look up table.

(20) An apparatus, comprising processing circuitry configured to obtain a diffusion-based probabilistic model that was trained, using at least one target image and at least one conditional image, to perform denoising over T steps, wherein T is an integer greater than or equal to two; obtain a start image; determine a shared phase representative image based on a plurality of phase images; generate a corresponding sequence of representative images by performing a first sequence of T1 denoising sampling steps using the obtained model starting with the start image and the shared phase representative image as initial first sequence inputs; determine, from the generated sequence of representative images, an intermediate image; and for each phase image in the plurality of phase images: generate a corresponding sequence of restored images by performing a second sequence of T2 denoising sampling steps using the obtained model with the intermediate image and the input image as initial second sequence inputs; and determine a final restored image for each phase image based on the generated corresponding sequence of restored images, wherein T1 and T2 are integers greater than or equal to 1.

Obviously, numerous modifications and variations are possible in light of the above teachings. It is therefore to be understood that within the scope of the appended claims, embodiment of the present disclosure may be practiced otherwise than as specifically described herein.

1. A method of denoising images, the method comprising:
obtaining a diffusion-based probabilistic model that was trained, using at least one target image and at least one conditional image, to perform denoising over T steps, wherein T is an integer greater than or equal to two;
obtaining a start image;
determining a shared phase representative image based on a plurality of phase images;
generating a sequence of representative images by performing a first sequence of T1 denoising sampling steps using the obtained model starting with the start image and the determined shared phase representative image as initial first sequence inputs;
determining, from the generated sequence of representative images, an intermediate image; and
for each phase image in the plurality of phase images:
generating a corresponding sequence of restored images by performing a second sequence of T2 denoising sampling steps using the obtained model with the intermediate image and the phase image as initial second sequence inputs; and
determining a corresponding final restored image for each phase image based on the generated corresponding sequence of restored images,
wherein T1 and T2 are integers greater than or equal to 1.

2. The method of claim 1, wherein T1 is greater than T2.

3. The method of claim 1, wherein T1 is less than T2.

4. The method of claim 1, wherein the step of generating the corresponding sequence of restored images comprises, for each sampling step in the sequence, supplying, as input to the obtained model, a preceding one of the sequence of restored images for phase image, and a value indicating the sampling step.

5. The method of claim 1, wherein the determining the intermediate image further comprises:
determining an image difference for a last image in the sequence of representative images compared to a first image in a first set of phase images and a first image in a second set of phase images is greater than a predetermined threshold; and
selecting a preceding image preceding the last image in the sequence of representative images.

6. The method of claim 5, further comprising determining the first set of phase images and the second set of phase images from the plurality of phase images by:
determining a first set of the plurality of phase images within a first time frame includes a first level of contrast agent below a first threshold value; and
determining a second set of the plurality of phase images within a second time frame includes a second level of contrast agent at or above the first threshold value.

7. The method of claim 1, wherein the step of determining the shared phase representative image comprises determining an average of each image of the plurality of phase images.

8. The method of claim 1, further comprising obtaining the plurality of phase images as a time sequence of reconstructed medical images.

9. The method of claim 1, further comprising determining the number T1 of denoising sampling steps for the generating of the sequence of representative images via a look-up table.

10. The method of claim 1, further comprising determining the number T1 of denoising sampling steps for the generating of the sequence of representative images via a manual input from an operator.

11. An apparatus, comprising:
processing circuitry configured to
obtain a diffusion-based probabilistic model that was trained, using at least one target image and at least one conditional image, to perform denoising over T steps, wherein T is an integer greater than or equal to two;
obtain a start image;
determine a shared phase representative image based on a plurality of phase images;
generate a sequence of representative images by performing a first sequence of T1 denoising sampling steps using the obtained model starting with the start image and the determined shared phase representative image as initial first sequence inputs;
determine, from the generated sequence of representative images, an intermediate image; and
for each phase image in the plurality of phase images:
generate a corresponding sequence of restored images by performing a second sequence of T2 denoising sampling steps using the obtained model with the intermediate image and the phase image as initial second sequence inputs; and
determine a corresponding final restored image for each phase image based on the generated corresponding sequence of restored images, wherein T1 and T2 are integers greater than or equal to 1.

12. The apparatus of claim 11, wherein T1 is greater than T2.

13. The apparatus of claim 11, wherein T1 is less than T2.

14. The apparatus of claim 11, wherein the processing circuitry is further configured to generate the corresponding sequence of restored images by for each sampling step in the sequence, supplying, as input to the obtained model, a preceding one of the sequence of restored images for the phase image, and a value indicating the sampling step.

15. The apparatus of claim 11, wherein the processing circuitry is further configured to determine the intermediate image by
determining an image difference for a last image in the sequence of representative images compared to a first image in a first set of phase images and a first image in a second set of phase images is greater than a predetermined threshold, and
selecting a preceding image preceding the last image in the sequence of representative images.

16. The apparatus of claim 15, wherein the processing circuitry is further configured to determine the first set of phase images and the second set of phase images from the plurality of phase images by:
determining a first set of the plurality of phase images within a first time frame includes a first level of contrast agent below a first threshold value; and
determining a second set of the plurality of phase images within a second time frame includes a second level of contrast agent at or above the first threshold value.

17. The apparatus of claim 11, wherein the processing circuitry is further configured to determine the shared phase representative image by calculating an average of the plurality of phase images.

18. The apparatus of claim 11, wherein the processing circuitry is further configured to obtain the plurality of phase images as a time sequence of reconstructed medical images.

19. The apparatus of claim 11, wherein the processing circuitry is further configured to determine the number T1 of denoising sampling steps for the generating of the sequence of representative images via a look up table.

20. A non-transitory computer-readable storage medium storing computer-readable instructions that, when executed by a computer, cause the computer to perform a method, the method comprising:
obtaining a diffusion-based probabilistic model that was trained, using at least one target image and at least one conditional image, to perform denoising over T steps, wherein T is an integer greater than or equal to two;
obtaining a start image;
determining a shared phase representative image based on a plurality of phase images;
generating a sequence of representative images by performing a first sequence of T1 denoising sampling steps using the obtained model starting with the start image and the determined shared phase representative image as initial first sequence inputs;
determining, from the generated sequence of representative images, an intermediate image; and
for each phase image in the plurality of phase images:
generating a corresponding sequence of restored images by performing a second sequence of T2 denoising sampling steps using the obtained model with the intermediate image and the phase image as initial second sequence inputs; and
determining a corresponding final restored image for each phase image based on the generated corresponding sequence of restored images,
wherein T1 and T2 are integers greater than or equal to 1.
